(19) United States
(12) Patent Application Publication
(10) Pub. No.: US 2018/0018140 A1
(43) Pub. Date: Jan. 18, 2018

(54) DISPLAY CONTROL DEVICE, DISPLAY CONTROL SYSTEM, AND NON-TRANSITORY COMPUTER READABLE MEDIUM

(71) Applicant: FUJI XEROX CO., LTD., Tokyo (JP)

(72) Inventors: Takumi KOBAYASHI, Kanagawa (JP); Kohshiro INOMATA, Kanagawa (JP); Masayuki YAMAGUCHI, Kanagawa (JP); Tetsuo FUKASAWA, Kanagawa (JP)

(73) Assignee: FUJI XEROX CO., LTD., Tokyo (JP)

(21) Appl. No.: 15/592,557

(22) Filed: May 11, 2017

(30) Foreign Application Priority Data
Jul. 13, 2016 (JP) 2016-138141

(51) Int. Cl. G06F 3/14; G09G 5/12; G06T 3/40

(52) U.S. Cl. CPC G06F 3/1462; G06T 3/40; G09G 5/12

(57) ABSTRACT

A display control device includes a recognition unit and a controller. The recognition unit recognizes that a first area that has a specific size and in which a specific image is displayed is arranged on a display screen of a first display apparatus. After the recognition unit recognizes that the first area is arranged, the controller performs control to arrange, on a display screen of a second display apparatus, a second area that has the specific size and in which the specific image is displayed.

### CROSS-REFERENCE TO RELATED APPLICATIONS

This application is based on and claims priority under 35 USC 119 from Japanese Patent Application No. 2016-138141 filed Jul. 13, 2016.

### Background

### Technical Field

The present invention relates to a display control device, a display control system, and a non-transitory computer readable medium.

### SUMMARY

According to an aspect of the invention, there is provided a display control device including a recognition unit and a controller. The recognition unit recognizes that a first area that has a specific size and in which a specific image is displayed is arranged on a display screen of a first display apparatus. After the recognition unit recognizes that the first area is arranged, the controller performs control to arrange, on a display screen of a second display apparatus, a second area that has the specific size and in which the specific image is displayed.

### BRIEF DESCRIPTION OF THE DRAWINGS

An exemplary embodiment of the present invention will be described in detail based on the following figures, wherein:

FIG. 1 is a diagram illustrating an example overall configuration of an electronic conferencing system to which an exemplary embodiment of the present invention may be applied;

FIG. 2 is a diagram illustrating an example hardware configuration of a server, a master terminal, and slave terminals in the exemplary embodiment of the present invention;

FIG. 3 is a diagram illustrating basic-example screens displayed in the exemplary embodiment of the present invention;

FIGS. 4A and 4B are diagrams illustrating first-application-example screens displayed in the exemplary embodiment of the present invention;

FIGS. 5A and 5B are diagrams illustrating second-application-example screens displayed in the exemplary embodiment of the present invention;

FIG. 6 is a block diagram illustrating an example functional configuration of the electronic conferencing system in the exemplary embodiment of the present invention;

FIG. 7 is a flowchart illustrating an example of operations of the master terminal performed to synchronize enlargement areas in the electronic conferencing system in the exemplary embodiment of the present invention; and

FIG. 8 is a flowchart illustrating an example of operations of each slave terminal performed to synchronize the enlargement areas in the electronic conferencing system in the exemplary embodiment of the present invention.

### DETAILED DESCRIPTION

Hereinafter, an exemplary embodiment of the present invention will be described in detail with reference to the attached drawings.

### Overall Configuration of Electronic Conferencing System

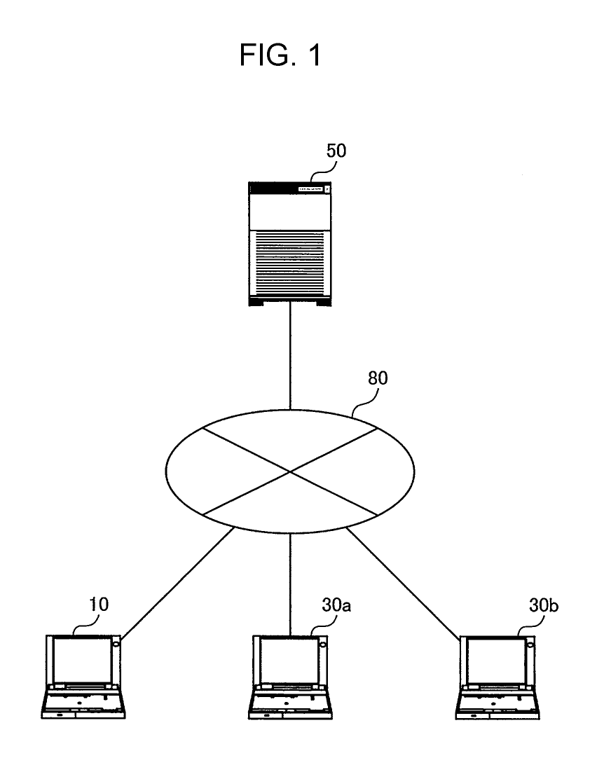

FIG. 1 is a diagram illustrating an example overall configuration of an electronic conferencing system to which the exemplary embodiment may be applied. As illustrated in FIG. 1, the electronic conferencing system includes a master terminal 10, slave terminals 30a and 30b, and a server 50 that are connected to a communication network 80. The slave terminals 30a and 30b illustrated in FIG. 1 may also be referred to as the slave terminals 30 when not needed to be discriminated from each other. In addition, the two slave terminals 30 are illustrated in FIG. 1, but three or more slave terminals 30 may be provided.

The master terminal 10 is a terminal apparatus used by a master terminal user. The term “master terminal user” denotes a person who makes presentation at a conference. The master terminal 10 displays data regarding a document referenced by the master terminal user at the presentation (hereinafter, simply referred to as a document). When the master terminal user performs an operation such as editing graphics or text in the document or turning pages, operation information indicating the operation that has been performed is transmitted to the server 50 to display the document in synchronization with the document displayed on the slave terminals 30. In the exemplary embodiment, the master terminal 10 is provided as an example of a first apparatus.

The slave terminals 30 are terminal apparatuses used by slave terminal users. The term “slave terminal user” denotes a person, aside from the master terminal user, who attends at the conference. Any slave terminal user may request to swap roles with the master terminal user. If the master terminal user accepts the request, the slave terminal user may serve as the master terminal user. Each slave terminal 30 displays the document referenced by the master terminal user at the presentation. At this time, the slave terminal 30 receives operation information from the server 50 such that the displayed document is synchronized with the document displayed on the master terminal 10. In the exemplary embodiment, the slave terminal 30 is provided as an example of a second apparatus.

The server 50 stores therein the document to be referenced by the master terminal user at the presentation and transmits the document to the master terminal 10 and the slave terminals 30. The server 50 also receives the operation information from the master terminal 10 and transmits the operation information to the slave terminals 30. The server 50 thereby performs control to synchronize the document displayed on the slave terminals 30 with the document displayed on the master terminal 10.

The communication network 80 is a communication medium used for information communication between the master terminal 10 and the server 50 and between the slave terminals 30 and the server 50. For example, a local area network (LAN) or the Internet may be used as the communication network 80.

### Hardware Configuration of Server, Master Terminal, and Slave Terminals

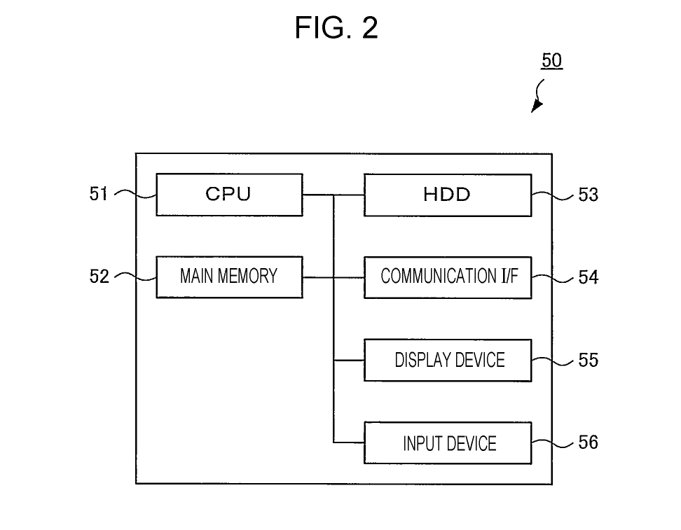

FIG. 2 is a diagram illustrating an example hardware configuration of the server 50 in the exemplary embodiment. As illustrated in FIG. 2, the server 50 includes a central processing unit (CPU) 51 that is an arithmetic unit, a main memory 52 that is a memory, and a hard disk drive (HDD) 53. The CPU 51 runs various pieces of software such as an operating system (OS) and applications and thereby implements functions to be described later. The main memory 52 is a memory area where the software and data used for running the software are stored. The HDD 53 is a memory area where data to be input to the software and data output from the software are stored. The server 50 includes a communication interface (I/F) 54 for communicating with an external apparatus, a display device 55 such as a display, and an input device 56 such as a keyboard or a mouth.

The hardware configuration illustrated in FIG. 2 may also be regarded as the hardware configuration of each of the master terminal 10 and the slave terminals 30. In the description of the master terminal 10, a CPU 11, a main memory 12, a HDD 13, a communication I/F 14, a display device 15, and an input device 16 of the master terminal 10 respectively correspond to the CPU 51, the main memory 52, the HDD 53, the communication I/F 54, the display device 55, and the input device 56 in FIG. 2. In the description of each slave terminal 30, a CPU 31, a main memory 32, a HDD 33, a communication I/F 34, a display device 35, and an input device 36 of the slave terminal 30 respectively correspond to the CPU 51, the main memory 52, the HDD 53, the communication I/F 54, the display device 55, and the input device 56 in FIG. 2.

In the exemplary embodiment, the display device 15 is provided as an example of a first display apparatus, the screen of the display device 15 is provided as an example of a first display screen, the display device 35 is provided as an example of a second display apparatus, and the screen of the display device 35 is provided as an example of the second display screen.

### Exemplary Embodiment Overview

In the electronic conferencing system as described above in the exemplary embodiment, when the master terminal user intends to enlarge a part of the document displayed on the master terminal 10 (hereinafter, referred to as an “enlargement-target part”) and enlarges the part, the actual size of an area in which one or more enlarged objects are displayed (hereinafter, referred to as an “enlargement area”) on each slave terminal 30 in synchronization with the enlargement area displayed on the master terminal 10 is made equal to the actual size of the enlargement area displayed on the master terminal 10. However, simply matching the actual sizes of the enlargement areas might cause a problem, depending on the screen size relationship between the master terminal 10 and the slave terminal 30. In this case, display adjustment may be performed to display the enlargement areas. The enlargement area of the master terminal 10 is an example of a first area, and the enlargement area of the slave terminal 30 is an example of a second area.

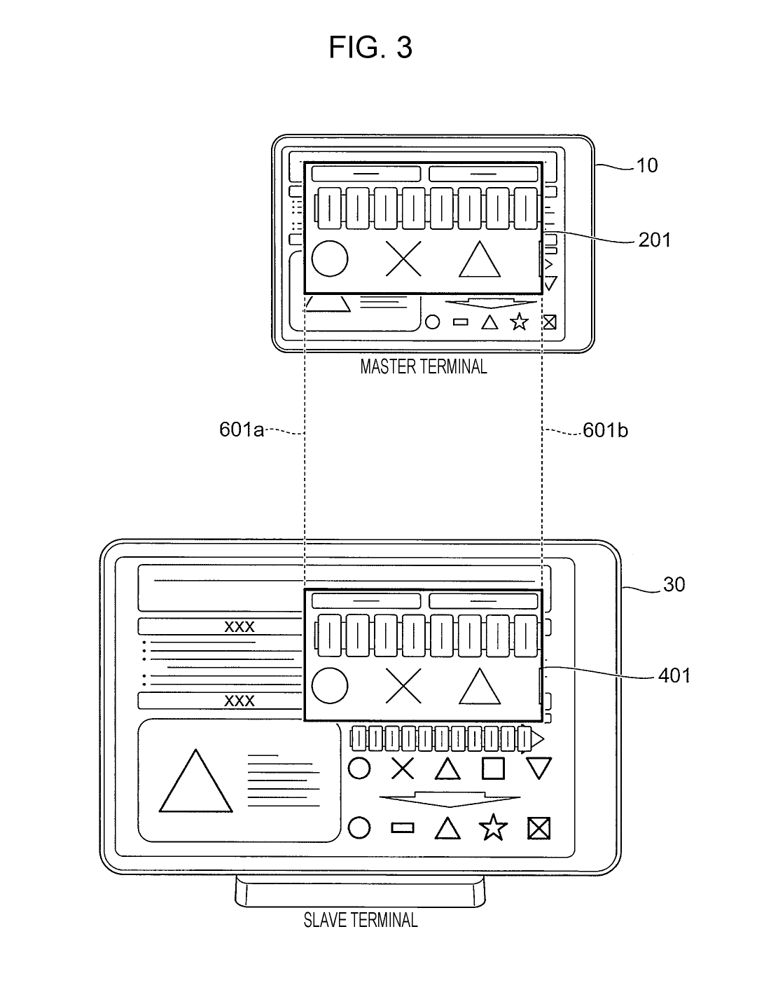

FIG. 3 is a diagram illustrating basic-example screens displayed in the exemplary embodiment of the present invention. The basic-example screens are example screens displayed when each enlargement area of the corresponding slave terminal 30 is synchronized with the enlargement area in which the enlargement-target part of the document is enlarged and displayed by the master terminal 10. As illustrated in FIG. 3, objects displayed in an enlargement area 201 by the master terminal 10 are also displayed in an enlargement area 401 by each slave terminal 30. As illustrated by broken lines 601a and 601b, the actual size of the enlargement area 201 is equal to the actual size of the enlargement area 401.

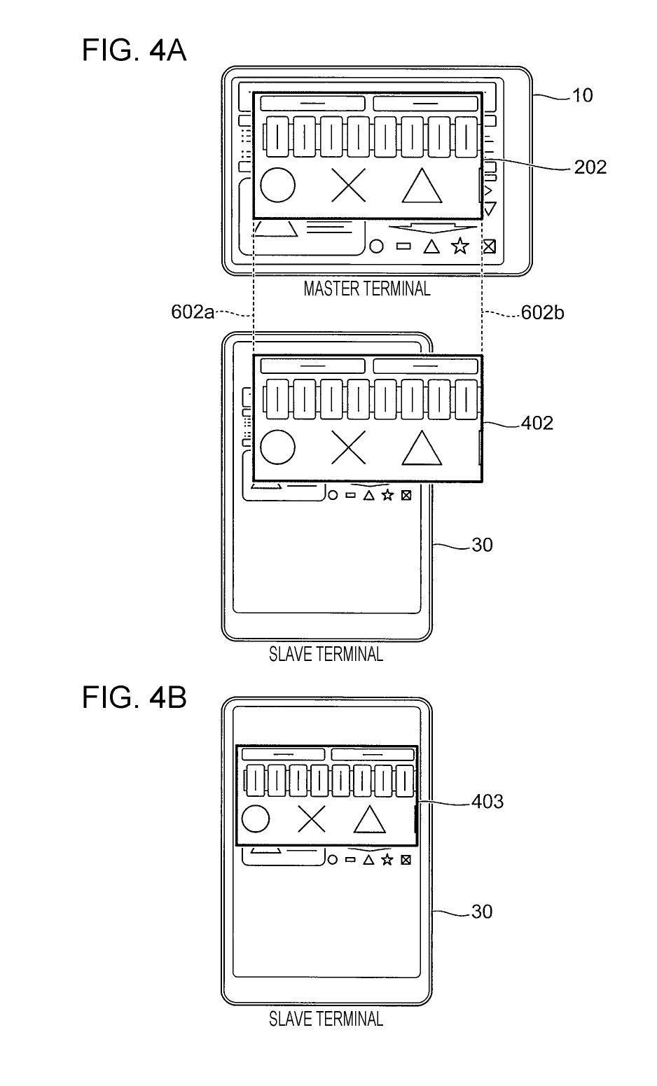

FIGS. 4A and 4B are diagrams illustrating first-application-example screens displayed in the exemplary embodiment. The first-application-example screens are example screens displayed when an enlargement area is not completely accommodated within the screen of one of the slave terminals 30. As illustrated in FIG. 4A, objects displayed in an enlargement area 202 by the master terminal 10 are also displayed in an enlargement area 402 by the slave terminal 30. As indicated by broken lines 602a and 602b, the actual size of the enlargement area 202 is equal to the actual size of the enlargement area 402. However, in this case, the screen of the slave terminal 30 is small, and thus the enlargement area 402 protrudes outside the screen. To cope with this, in the example as illustrated in FIG. 4B, the slave terminal 30 displays an enlargement area 403 of an actual size adjusted to be accommodated within the screen of the slave terminal 30.

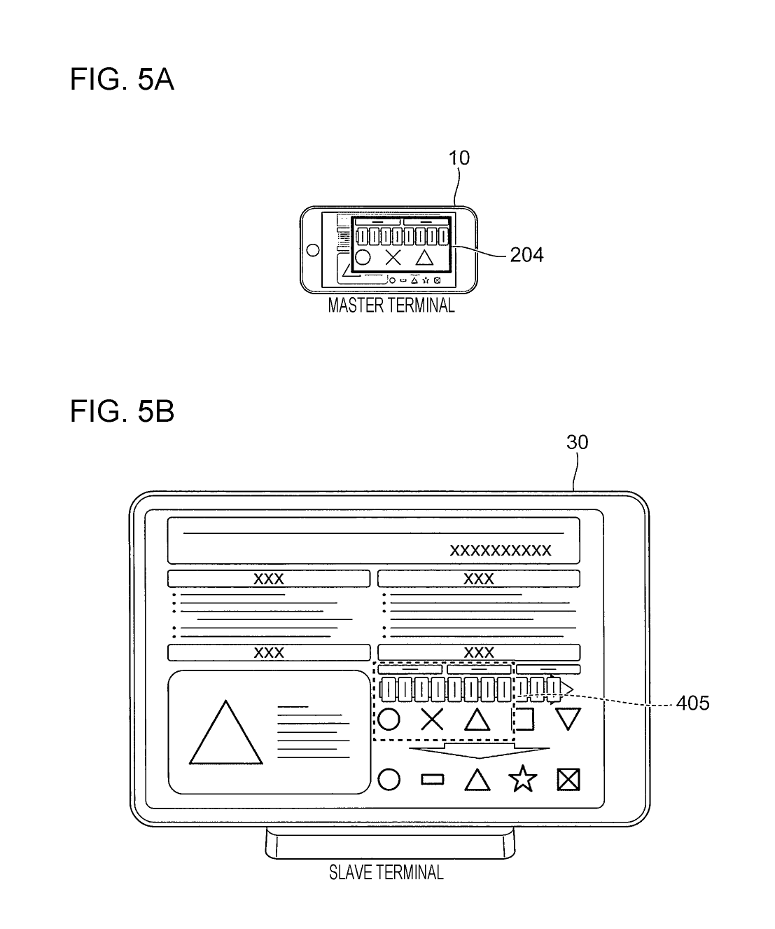

FIGS. 5A and 5B are diagrams illustrating second-application-example screens displayed in the exemplary embodiment. The second-application-example screens are example screens displayed when the enlargement-target part of the document is not enlarged in the enlargement area of the slave terminal 30. As illustrated in FIG. 5A, the master terminal 10 has a small screen and thus displays a small enlargement area 204. Accordingly, if an enlargement area of the same actual size as the actual size of the enlargement area 204 is displayed on the slave terminal 30, the actual size of the enlargement area displayed on the slave terminal 30 is smaller than the size of the enlargement-target part of the document displayed on the slave terminal 30. To cope with this, in the example as illustrated in FIG. 5B, the enlargement area of the same actual size as the actual size of the enlargement area 204 is not displayed on the slave terminal 30, but the enlargement-target part of the document displayed on the slave terminal 30 is emphasized using a frame 405.

The processes executed in the exemplary embodiment have herein described with reference to the example screens in FIGS. 3 to FIG. 5B, but not all of the processes do not have to be executed. For example, only the process described with reference to the example screens in FIG. 3 may be executed, and the processes described with reference to the example screens in FIGS. 4A to 5B do not have to be executed. In addition, only the processes described with reference to the example screens in FIGS. 3 to 4B may be executed, and the process described with reference to the example screens in FIGS. 5A and 5B does not have to be executed. Further, only the processes described with reference to the example screens in FIGS. 3, 5A, and 5B may be executed, and the process described with reference to the example screens in FIGS. 4A and 4B does not have to be executed. However, a case where all of the processes described with reference to the example screens FIGS. 3 to 5B are executed will hereinafter be described in detail.

### Functional Configuration of Electronic Conferencing System

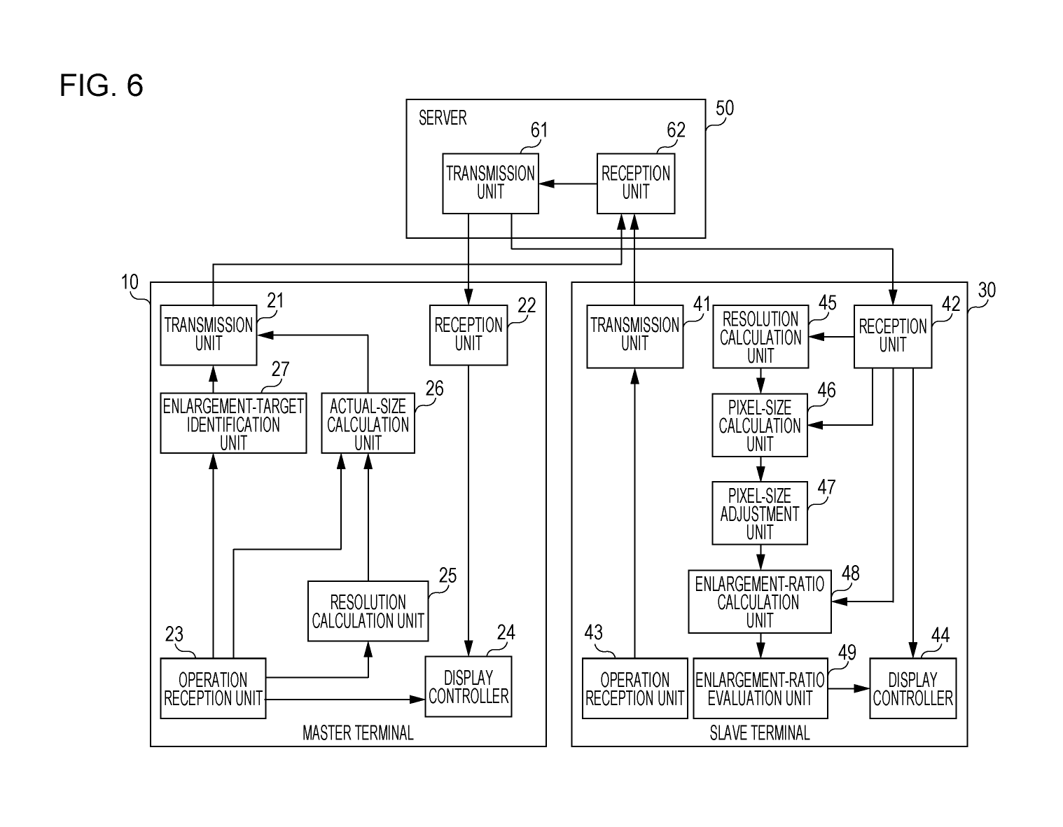

FIG. 6 is a block diagram illustrating an example functional configuration of apparatuses constituting the electronic conferencing system in the exemplary embodiment. As illustrated in FIG. 6, the electronic conferencing system in the exemplary embodiment includes the master terminal 10, the slave terminal 30, and the server 50. As described above, two or more slave terminals 30 may be provided, but only one slave terminal 30 is herein illustrated.

First, the example functional configuration of the master terminal 10 will be described. As illustrated in FIG. 6, the master terminal 10 includes a transmission unit 21, a reception unit 22, an operation reception unit 23, a display controller 24, a resolution calculation unit 25, an actual-size calculation unit 26, and an enlargement-target identification unit 27.

In a case where the document is displayed on the master terminal 10 and is synchronized with the document displayed on the slave terminal 30, the transmission unit 21 transmits, to the server 50, a document identifier (ID) of the document and a synchronization instruction. In a case where an enlargement area is displayed on the master terminal 10 and is synchronized with an enlargement area displayed on the slave terminal 30, the transmission unit 21 transmits, to the server 50, an instruction for synchronizing the enlargement areas (hereinafter, referred to as an “enlargement-area synchronization instruction”). The enlargement-area synchronization instruction includes information indicating the actual size of the enlargement area calculated by the actual-size calculation unit 26 and the enlargement-target part of the document identified by the enlargement-target identification unit 27. In the exemplary embodiment, the enlargement-area synchronization instruction is used as an example of recognition result information, and the transmission unit 21 is provided as an example of a transmission unit that transmits the recognition result information. When the master terminal 10 is an example of a display control device, the transmission unit 21 is also an example of a controller that performs control to arrange the second area on the display screen of the second display apparatus.

In the case where the document is displayed on the master terminal 10 and is synchronized with the document displayed on the slave terminal 30, the reception unit 22 receives the document from the server 50. The document has been extracted by the server 50 by using, as a key, the document ID having received from the master terminal 10 by a reception unit 62 and has been transmitted by a transmission unit 61 of the server 50.

In the case where the document is displayed on the master terminal 10 and is synchronized with the document displayed on the slave terminal 30, the operation reception unit 23 receives an operation for inputting the document ID of the document. In the case where the enlargement area is displayed on the master terminal 10 and is synchronized with the enlargement area displayed on the slave terminal 30, the operation reception unit 23 receives an operation for displaying the enlargement area.

In the case where the document is displayed on the master terminal 10 and is synchronized with the document displayed on the slave terminal 30, the display controller 24 performs control of the display device 15 to display the document thereon. In the case where the enlargement area is displayed on the master terminal 10 and is synchronized with the enlargement area displayed on the slave terminal 30, the display controller 24 performs control of the display device 15 to superpose the enlargement area to be synchronized on the document currently displayed on the display device 15.

In the case where the enlargement area is displayed on the master terminal 10 and is synchronized with the enlargement area displayed on the slave terminal 30, the resolution calculation unit 25 calculates the resolution (dpi) of the master terminal 10. The resolution of the master terminal 10 may be calculated from the value of devicePixelRatio or the like, that is, a window size acquirable using a JavaScript (registered trademark) application programming interface (API). The term “window size” in the specification denotes a size represented by the number of window pixels arranged lengthwise and the number of window pixels arranged widthwise.

In the case where the enlargement area is displayed on the master terminal 10 and is synchronized with the enlargement area displayed on the slave terminal 30, the actual-size calculation unit 26 calculates the actual size of the enlargement area. Specifically, the actual-size calculation unit 26 calculates the actual size of the enlargement area by dividing the pixel size of the enlargement area by the resolution calculated by the resolution calculation unit 25. The term “pixel size” of an area in the specification denotes a size represented by the number of area pixels arranged lengthwise and the number of area pixels arranged widthwise. Note that if an enlargement ratio has been determined, one pixel size of the enlargement area may be set in advance for the enlargement ratio. Alternatively, if one or more multiple enlargement ratios are selectable by the master terminal user, pixel sizes may be set in advance for the respective enlargement ratios. In the exemplary embodiment, the actual-size calculation unit 26 is provided as an example of a recognition unit that recognizes that the first area that has a specific size is arranged on the display screen of the first display apparatus.

In the case where the enlargement area is displayed on the master terminal 10 and is synchronized with the enlargement area displayed on the slave terminal 30, the enlargement-target identification unit 27 identifies an enlargement-target part and generates information indicating the enlargement-target part. The information indicating the enlargement-target part includes the location of the center of the enlargement-target part and the pixel size of the enlargement-target part. The location of the center of the enlargement-target part may be obtained from the location where the enlargement area is arranged. As the pixel size of the enlargement-target part, a pixel size set in advance for the predetermined enlargement ratio or for the enlargement ratio selected by the master terminal user may be used. In the exemplary embodiment, the enlargement-target identification unit 27 is provided as an example of the recognition unit that recognizes that the first area in which a specific image is displayed is arranged on the display screen of the first display apparatus.

The example functional configuration of the slave terminal 30 will be described. As illustrated in FIG. 6, the slave terminal 30 includes a transmission unit 41, a reception unit 42, an operation reception unit 43, a display controller 44, a resolution calculation unit 45, a pixel-size calculation unit 46, a pixel-size adjustment unit 47, an enlargement-ratio calculation unit 48, and an enlargement-ratio evaluation unit 49.

In a case where the document displayed on the slave terminal 30 is synchronized with that displayed on the master terminal 10, the transmission unit 41 does not particularly function. However, in other scenarios, the transmission unit 41 transmits various pieces of operation information indicating operations to the server 50.

In the case where the document displayed on the slave terminal 30 is synchronized with that displayed on the master terminal 10, the reception unit 42 receives the document. The document has been extracted by the server 50 by using, as a key, the document ID having received from the master terminal 10 by the reception unit 62 and has been transmitted by the transmission unit 61. In a case where the enlargement area displayed on the slave terminal 30 is synchronized with that displayed on the master terminal 10, the reception unit 42 receives the enlargement-area synchronization instruction from the server 50. As described above, the enlargement-area synchronization instruction includes the actual size of the enlargement area and the information indicating the enlargement-target part of the document. In the exemplary embodiment, the reception unit 42 is provided as an example of a reception unit that receives the recognition result information. When the slave terminal 30 is an example of the display control device, the reception unit 42 is an example of the recognition unit that recognizes that the first area that has the specific size and in which the specific image is displayed is arranged on the display screen of the first display apparatus.

In the case where the document displayed on the slave terminal 30 is synchronized with that displayed on the master terminal 10, the operation reception unit 43 does not particularly function. However, in other scenarios, the operation reception unit 43 receives various operations.

In the case where the document displayed on the slave terminal 30 is synchronized with that displayed on the master terminal 10, the display controller 44 performs control of the display device 35 to display the document. In the case where the enlargement area displayed on the slave terminal 30 is synchronized with that displayed on the master terminal 10, the display controller 44 performs control of the display device 35 to superpose the enlargement area to be synchronized on the document currently displayed on the display device 35. In the exemplary embodiment, the display controller 44 is provided as an example of the controller that performs control to arrange the second area on the display screen of the second display apparatus.

In the case where the enlargement area displayed on the slave terminal 30 is synchronized with that displayed on the master terminal 10, the resolution calculation unit 45 calculates the resolution (dpi) of the slave terminal 30. The resolution of the slave terminal 30 may also be calculated from the value of devicePixelRatio or the like, that is, a window size acquirable using the JavaScript (registered trademark) API.

In the case where the enlargement area displayed on the slave terminal 30 is synchronized with that displayed on the master terminal 10, the pixel-size calculation unit 46 calculates the pixel size of the enlargement area. Specifically, the pixel-size calculation unit 46 calculates the pixel size of the enlargement area by multiplying the actual size of the enlargement area included in the enlargement-area synchronization instruction received from the server 50 by the resolution calculated by the resolution calculation unit 45.

In the case where the enlargement area displayed on the slave terminal 30 is synchronized with that displayed on the master terminal 10, the pixel-size adjustment unit 47 detects excess of the pixel size of the enlargement area calculated by the pixel-size calculation unit 46 over the window size of the slave terminal 30. The pixel-size adjustment unit 47 reduces, to the same size as the window size, the pixel size of the enlargement area extending in a direction in which the pixel size exceeds the window size and reduces the pixel size in the other direction by using the same reduction ratio.

In the case where the enlargement area displayed on the slave terminal 30 is synchronized with that displayed on the master terminal 10, the enlargement-ratio calculation unit 48 calculates the enlargement ratio to be used when the enlargement-target part of the document displayed on the slave terminal 30 is enlarged and displayed in the enlargement area. Specifically, the enlargement-ratio calculation unit 48 calculates the enlargement ratio in such a manner that the pixel size of the enlargement area calculated by the pixel-size calculation unit 46 or the pixel size of the enlargement area adjusted by the pixel-size adjustment unit 47, if any, is divided by the pixel size of the enlargement-target part included in the enlargement-area synchronization instruction received from the server 50.

In the case where the enlargement area displayed on the slave terminal 30 is synchronized with that displayed on the master terminal 10, the enlargement-ratio evaluation unit 49 evaluates whether the enlargement ratio calculated by the enlargement-ratio calculation unit 48 is larger than 1. If the enlargement ratio is larger than 1, the enlargement-ratio evaluation unit 49 instructs the display controller 44 to display the enlargement area. If the enlargement ratio is equal to or smaller than 1, the enlargement-ratio evaluation unit 49 instructs the display controller 44 not to display the enlargement area but to display and emphasize the enlargement-target part indicated by the information included in the enlargement-area synchronization instruction received from the server 50.

The example functional configuration of the server 50 will be described. As illustrated in FIG. 6, the server 50 includes the transmission unit 61 and the reception unit 62.

In a case where the document displayed on the master terminal 10 and the document displayed on the slave terminal 30 are synchronized, the transmission unit 61 transmits the document to the master terminal 10. In a case where the enlargement area displayed on the master terminal 10 and the enlargement area displayed on the slave terminal 30 are synchronized, the transmission unit 61 transmits the enlargement-area synchronization instruction to the slave terminal 30.

In the case where the document displayed on the master terminal 10 and the document displayed on the slave terminal 30 are synchronized, the reception unit 62 receives the document ID of the document and the synchronization instruction from the master terminal 10. In the case where the enlargement area displayed on the master terminal 10 and the enlargement area displayed on the slave terminal 30 are synchronized, the reception unit 62 receives the enlargement-area synchronization instruction from the master terminal 10. Further, the reception unit 62 receives various pieces of operation information indicating operations from the slave terminal 30 in some cases, not in the case where the enlargement area displayed on the master terminal 10 and the enlargement area displayed on the slave terminal 30 are synchronized.

In the example functional configuration illustrated in FIG. 6, the server 50 typically has a function for transmitting, to the slave terminal 30, the information transmitted from the master terminal 10. However, the server 50 may have the functions of the master terminal 10 and the slave terminal 30. For example, the master terminal 10 does not include the resolution calculation unit 25, the actual-size calculation unit 26, or the enlargement-target identification unit 27, but the reception unit 62 of the server 50 has the functions of these components. The slave terminal 30 does not include the resolution calculation unit 45, the pixel-size calculation unit 46, the pixel-size adjustment unit 47, the enlargement-ratio calculation unit 48, or the enlargement-ratio evaluation unit 49, but the transmission unit 61 of the server 50 has the functions of these components. However, some change is needed in this case. For example, the reception unit 62 does not calculate the resolution of the master terminal 10 but acquires the resolution in advance from the master terminal 10, and the transmission unit 61 does not calculate the resolution of the slave terminal 30 but acquires the resolution in advance from the slave terminal 30. Note that in this case, the server 50 serves as an example of the display control device, the reception unit 62 serves as an example of the recognition unit that recognizes that the first area that has a specific size and in which a specific image is displayed is arranged on the display screen of the first display apparatus, and the transmission unit 61 serves as an example of the controller that performs control to arrange the second area on the display screen of the second display apparatus. Alternatively, the master terminal 10 may directly transmit the operation information to the slave terminal 30, with the server 50 not being provided. Nevertheless, the description of operations described below is provided on the basis of the example functional configuration illustrated in FIG. 6.

### Operations of Electronic Conferencing System

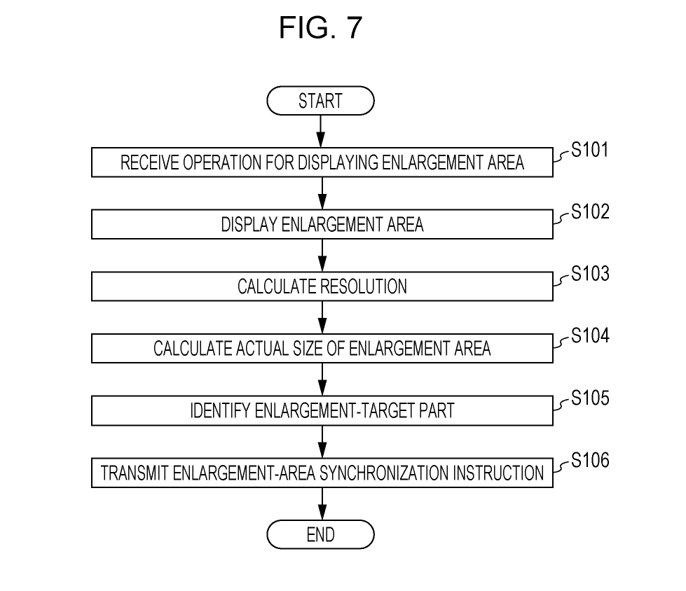

FIG. 7 is a flowchart illustrating an example of operations of the master terminal 10 performed to synchronize enlargement areas in the electronic conferencing system in the exemplary embodiment. Prior to the operations, in the master terminal 10, the reception unit 22 has received a document from the server 50, and the document has been displayed on the master terminal 10 under the control of the display controller 24.

As illustrated in FIG. 7, when the master terminal user performs an operation for displaying an enlargement area, the operation reception unit 23 of the master terminal 10 receives the operation (step S101). The display controller 24 then performs control of the display device 15 to display the enlargement area (step S102). This causes the enlargement area to be displayed on the master terminal 10.

The resolution calculation unit 25 calculates the resolution (dpi) of the master terminal 10 (step S103). The actual-size calculation unit 26 calculates the actual size of the enlargement area by dividing the predetermined pixel size of the enlargement area by the resolution calculated in step S103 (step S104).

The enlargement-target identification unit 27 identifies the enlargement-target part of the document displayed on the master terminal 10 (step S105).

Finally, the transmission unit 21 transmits, to the server 50, an enlargement-area synchronization instruction including the actual size of the enlargement area calculated in step S104 and information indicating the enlargement-target part identified in step S105 (step S106). This causes the reception unit 62 of the server 50 to receive the enlargement-area synchronization instruction and the transmission unit 61 to transmit the enlargement-area synchronization instruction to the slave terminal 30. However, these steps are not illustrated.

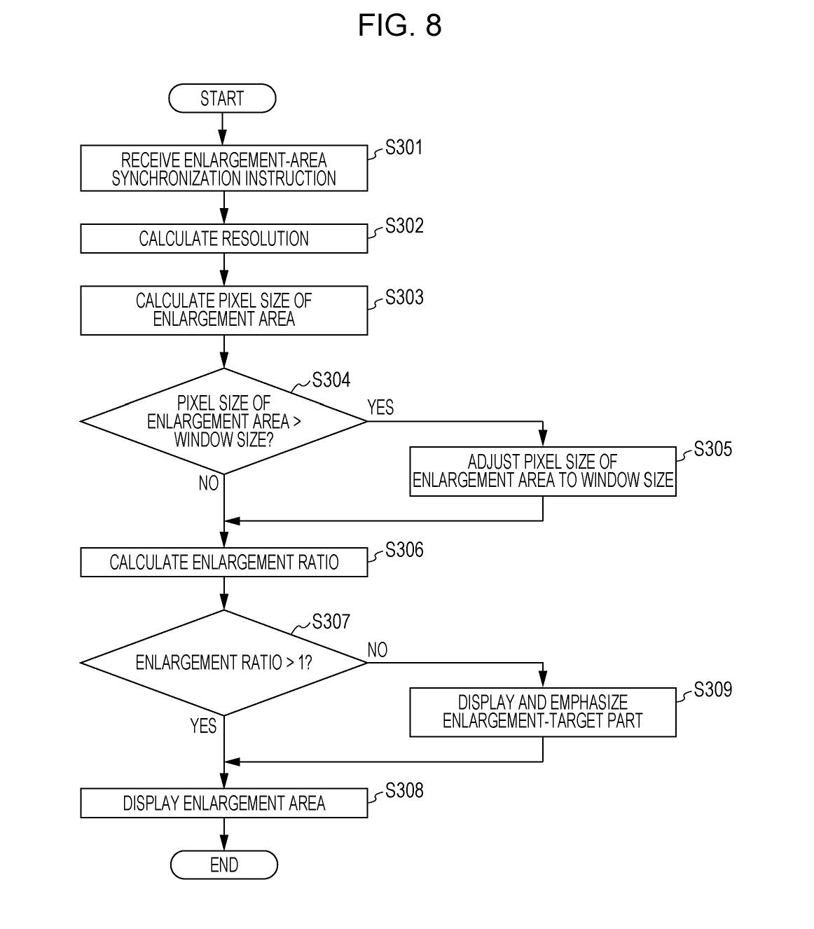

FIG. 8 is a flowchart illustrating an example of operations of the slave terminal 30 performed to synchronize the enlargement areas in the electronic conferencing system in the exemplary embodiment.

As illustrated in FIG. 8, the reception unit 42 of the slave terminal 30 receives the enlargement-area synchronization instruction transmitted from the server 50 as described above (step S301).

The resolution calculation unit 45 calculates the resolution (dpi) of the slave terminal 30 (step S302). The pixel-size calculation unit 46 calculates the pixel size of the enlargement area by multiplying the actual size of the enlargement area included in the enlargement-area synchronization instruction received in step S301 by the resolution calculated in step S302 (step S303). The pixel-size adjustment unit 47 determines whether the pixel size of the enlargement area calculated in step S303 is larger than the window size (step S304). If it is consequently determined that the pixel size of the enlargement area is larger than the window size, the pixel-size adjustment unit 47 adjusts the pixel size of the enlargement area to the window size (step S305). Specifically, the pixel-size adjustment unit 47 reduces, to the same size as the window size, the pixel size of the enlargement area extending in the direction in which the pixel size exceeds the window size and reduces the pixel size in the other direction by using the same reduction ratio.

The enlargement-ratio calculation unit 48 calculates the enlargement ratio in such a manner that the pixel size of the enlargement area calculated in step S303 or the pixel size of the enlargement area adjusted in step S305 in the case of the larger pixel size of the enlargement area than the window size is divided by the pixel size of the enlargement-target part included in the enlargement-area synchronization instruction received in step S301 (step S306). The enlargement-ratio evaluation unit 49 determines whether the enlargement ratio calculated in step S306 is larger than 1 (step S307). If it is consequently determined that the enlargement ratio is larger than 1, the display controller 44 performs control of the display device 35 to display the enlargement area (step S308). This causes the enlargement area to be displayed on the slave terminal 30. In contrast, if it is determined that the enlargement ratio is not larger than 1, the display controller 44 performs control of the display device 35 to display and emphasize the enlargement-target part indicated by the information included in the enlargement-area synchronization instruction received in step S301 (step S309). This causes the enlargement-target part of the document to be displayed on the slave terminal 30 and emphasized by using, for example, a broken line.

Note that in the exemplary embodiment, if the master terminal user enlarges the enlargement-target part of the document displayed on the master terminal 10, the enlargement areas respectively displayed on the slave terminal 30 and the master terminal 10 in synchronization with each other have the same actual size. However, the configuration is not limited to this configuration. If the master terminal user does not enlarge the document displayed on the master terminal 10, areas for respectively displaying a part of the document and a corresponding synchronized part may have the same actual size.

Although the case where the exemplary embodiment of the present invention is applied to the electronic conferencing system has been described, the exemplary embodiment may be applied to a system other than the electronic conferencing system. For example, a lecture system used at a school or the like is conceivable as a system other than the electronic conferencing system. In such a system, the master terminal user is a teacher, and the slave terminal users are students. In addition, teaching materials, instead of the document, may be synchronized in such a system. Alternatively, on the assumption that a general system other than the electronic conferencing system is used, images may be synchronized.

### Program

The processes performed by the master terminal 10, the slave terminal 30, and the server 50 in the exemplary embodiment are provided as a program such as application software.

That is, the program implementing the exemplary embodiment is regarded as a program causing a computer to implement a function of recognizing that the first area that has a specific size and in which a specific image is displayed is arranged on the display screen of the first display apparatus and a function of performing control to arrange, on the display screen of the second display apparatus, the second area that has the specific size and in which the specific image is displayed, the control being performed after the first area is recognized to be arranged.

Note that the program implementing the exemplary embodiment may be provided through the communication medium, as a matter of course, and in such a manner as to be stored in a recording medium such as a compact disk read-only memory (CD-ROM).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display control device comprising:
a recognition unit that recognizes that a first area that has a specific size and in which a specific image is displayed is arranged on a display screen of a first display apparatus; and
a controller that performs control to arrange, on a display screen of a second display apparatus, a second area that has the specific size and in which the specific image is displayed, the control being performed after the recognition unit recognizes that the first area is arranged.

2. The display control device according to claim 1,
wherein after a first image displayed on the display screen of the first display apparatus is converted into a second image such that a size of the second image matches a size of the display screen of the second display apparatus, the controller performs control to display the second image on the display screen of the second display apparatus.

3. The display control device according to claim 2,
wherein the specific image is an image obtained by enlarging a part of the first image displayed on the display screen of the first display apparatus.

4. The display control device according to claim 1,
wherein if the second area is not completely accommodated within the display screen of the second display apparatus, the controller performs control to reduce the second area and to arrange the reduced second area on the display screen of the second display apparatus.

5. The display control device according to claim 1,
wherein if the second area is smaller than a part that corresponds to the specific image and that is included in an image displayed on the display screen of the second display apparatus, the controller performs control to emphasize and display the part.

6. A display control system comprising:
a first apparatus that displays an image on a first display screen; and
a second apparatus that displays an image on a second display screen,
the first apparatus including
a recognition unit that recognizes that a first area that has a specific size and in which a specific image is displayed is arranged on the first display screen, and
a transmission unit that transmits recognition result information indicating a result of recognition performed by the recognition unit,
the second apparatus including
a reception unit that receives the recognition result information, and
a controller that performs control to arrange, on the second display screen, a second area that has the specific size and in which the specific image is displayed, the control being performed after the reception unit receives the recognition result information.

7. A non-transitory computer readable medium storing a program causing a computer to execute a process for display control, the process comprising:
recognizing that a first area that has a specific size and in which a specific image is displayed is arranged on a display screen of a first display apparatus; and
performing control to arrange, on a display screen of a second display apparatus, a second area that has the specific size and in which the specific image is displayed, the control being performed after the first area is recognized to be arranged.
